(19) United States
(12) Patent Application Publication
(10) Pub. No.: US 2026/0218875 A1
(43) Pub. Date: Jul. 30, 2026

(54) DEVICE COMPRISING ILLUMINATED MOVABLE CLOSURE ELEMENTS

(71) Applicant: VALEO VISION, Bobigny (FR)

(72) Inventor: Rabih TALEB, Bobigny (FR)

(73) Assignee: VALEO VISION, Bobigny (FR)

(21) Appl. No.: 19/150,676

(22) PCT Filed: Jan. 21, 2024
(86) PCT No.: PCT/EP2024/051325

§ 371 Date: Jul. 24, 2025

(30) Foreign Application Priority Data
Jan. 25, 2023 (FR) 2300681

(51) Int. Cl. F21S 43/50; B60K 11/08; F21S 43/19; F21S 43/31; F21S 43/37; F21S 45/20; F21W 104/00

(52) U.S. Cl. CPC F21S 43/51; B60K 11/085; F21S 43/19; F21S 43/31; F21S 43/37; F21S 45/20; F21W 2104/00

(57) ABSTRACT

The invention relates to a device for an automotive vehicle. The device includes at least two movable shutter elements having a first face and a second face, and an actuator capable of moving the movable shutter elements into a closed position of the device and into at least one open position of the device. The device further includes a light source arranged to emit light rays towards a movable shutter element of which the first face is arranged facing a second face of another movable shutter element, in the open position. The movable shutter element towards which the light rays from the source are emitted is rigidly connected to a reflective element capable of reflecting at least some of the emitted light rays towards the second face of the other movable shutter element, in the at least one open position.

### TECHNICAL FIELD

The present invention relates to the field of lighting shutter elements of a device for an automotive vehicle. It relates in particular to a device capable of lighting, and thus making visible, its shutter elements.

It is particularly advantageous in the case where the device performs a thermal function in the vehicle, for example to ventilate/cool a component located behind a frame of the shutter device.

### BACKGROUND OF THE INVENTION

Devices for automotive vehicles comprising movable shutter elements are known, the movable shutter elements being movable between an open or closed position in order to selectively allow an air flow to pass through, thereby cooling a component located behind the device, for example the engine of the vehicle. Such a device is called an active grille shutter (AGS). The devices for ventilating the inside of the vehicle also comprise movable shutter elements which can be moved to allow or prevent an air flow toward the inside of the vehicle.

However, such devices are not lighted to enable the shutter elements to be seen, notably to determine whether the shutter elements are in the open or closed position.

Furthermore, the fact that the shutter elements are movable and can occupy several partially open positions makes it difficult to light them.

### SUMMARY OF THE INVENTION

There is thus a need to light movable shutter elements of a device for an automotive vehicle, in consideration of the movement of the movable shutter elements, which adapts to the shape of the movable shutter elements, which requires few structural modifications of the device, and which takes into account the weight constraints inherent in automotive vehicles. Moreover, it is preferable for the lighting of the movable shutter element to be uniform.

To this end, a first aspect of the invention relates to a device for an automotive vehicle, comprising:
at least two movable shutter elements, each movable shutter element comprising a first face and a second face;
an actuator capable of moving said at least two movable shutter elements to a closed position of the device and to at least one open position of the device;
at least one light source arranged to emit light rays toward at least one movable shutter element, the first face of which is arranged to face a second face of another movable shutter element, in the at least one open position;

in which the at least one movable shutter element toward which the light rays from said at least one source are emitted is integral with a reflective element capable of reflecting at least some of the emitted light rays toward the second face of the other movable shutter element, in the at least one open position.

Thus, the second face of at least one movable shutter element is lighted, and made visible, via a reflective element constrained to move with the movable shutter elements. This enables dynamic lighting of the device for an automotive vehicle. The reflective element may be obtained by treating a surface of the first face, such as by adding reflective paint, or may be an additional element, such as a mirror.

According to embodiments, the device may comprise at least two reflective elements arranged to reflect some of the light rays from the light source toward at least two respective second faces of two movable shutter elements.

This enables the second faces of several movable shutter elements, or even of all the movable shutter elements of the device, to be lighted, which improves the visibility of the device in the open position for an observer outside the device.

In addition, according to a first embodiment of the invention, said at least one light source may comprise at least one luminous element able and arranged to emit light rays toward said at least two reflective elements.

Thus, a given luminous element can light several movable shutter elements, which reduces the number of luminous elements in the light source and therefore its size. The bulk associated with the lighting function of the device is thus reduced.

In a variant, according to a second embodiment, said at least one light source may comprise at least two luminous elements, each luminous element being able and arranged to emit light rays toward only one of the at least two reflective elements.

The use of dedicated luminous elements provides better luminous efficacy than a shared source. In addition, less powerful, and therefore less expensive, luminous elements can be used.

According to embodiments, the movable shutter elements may extend longitudinally in a first direction, said at least one light source may extend longitudinally in the first direction, and said at least one light source may comprise at least one luminous element for each longitudinal position in a set of longitudinal positions in the first direction.

This enables large movable shutter elements to be lighted in a uniform manner.

In addition, for each longitudinal position, the device may comprise N reflective elements and the light source may comprise N luminous elements, each luminous element being capable of emitting light rays to only one of the N reflective elements, N being greater than or equal to 2.

This improves the luminous efficacy of the light source while uniformly lighting movable shutter elements, which may be large.

In addition, for each longitudinal position, the luminous elements may be arranged on a face of a given support, the face of the support may be shaped to define respective inclinations of the luminous elements and/or respective positions of the luminous elements along a first axis perpendicular to a longitudinal axis and along a second axis perpendicular to the longitudinal axis, the first axis and the second axis being perpendicular to each other. The respective inclinations and/or positions along the first and second axes perpendicular to the longitudinal axis may be different for at least two reflective elements of the N reflective elements.

This optimizes the lighting of the movable shutter elements, notably as a function of the respective geometries and arrangements of the movable shutter elements, and of the position of the light source.

According to embodiments, the device may further comprise a frame and a reflective element fastened to said frame, said at least one light source may be capable of emitting light rays toward the reflective element fastened to said frame, and the reflective element fastened to the frame may be capable of reflecting at least some of the light rays toward a second face of a movable shutter element, the second face of which is not facing any first face of another movable shutter element.

This enables the second face of the movable shutter element in the extreme position, for example the one closest to the frame of the device, to be lighted. Thus, all the movable shutter elements of the device can be lighted according to the invention.

According to a third embodiment, the actuator may be capable of generating a mechanical force to move said movable shutter elements, the device may further comprise a mechanical element capable of transmitting the mechanical force generated by the actuator to said at least one light source.

Thus, the lighting of the movable shutter elements can be adapted to their movement, which improves the luminous efficacy but also the uniformity of the lighting between the different open positions.

In addition, the mechanical element may be a camshaft capable of converting the mechanical force of the actuator into a path of the light source by means of a non-linear function.

This optimizes the path of the light source as a function of the successive open positions of the movable shutter elements.

### BRIEF DESCRIPTION OF DRAWINGS

Other features and advantages of the invention will become apparent on examining the following detailed description and the appended drawings, in which:

FIG. 1 is a front view of a device for an automotive vehicle according to embodiments of the invention;

FIG. 2a is a side view of a device for an automotive vehicle according to a first embodiment, in a first configuration;

FIG. 2b is a side view of a device for an automotive vehicle according to the first embodiment, in a second configuration;

FIG. 3 is a side view of a device for an automotive vehicle according to a second embodiment, in a given configuration;

FIG. 4 shows a light source of a device for an automotive vehicle, according to the second embodiment of the invention;

FIG. 5a is a side view of a device for an automotive vehicle according to a third embodiment, in a first configuration;

FIG. 5b is a side view of a device for an automotive vehicle according to a third embodiment, in a second configuration; and

FIG. 5c is a side view of a device for an automotive vehicle according to a third embodiment, in a third configuration.

### DETAILED DESCRIPTION OF THE INVENTION

The description concentrates on the features that differentiate the device from those known in the prior art.

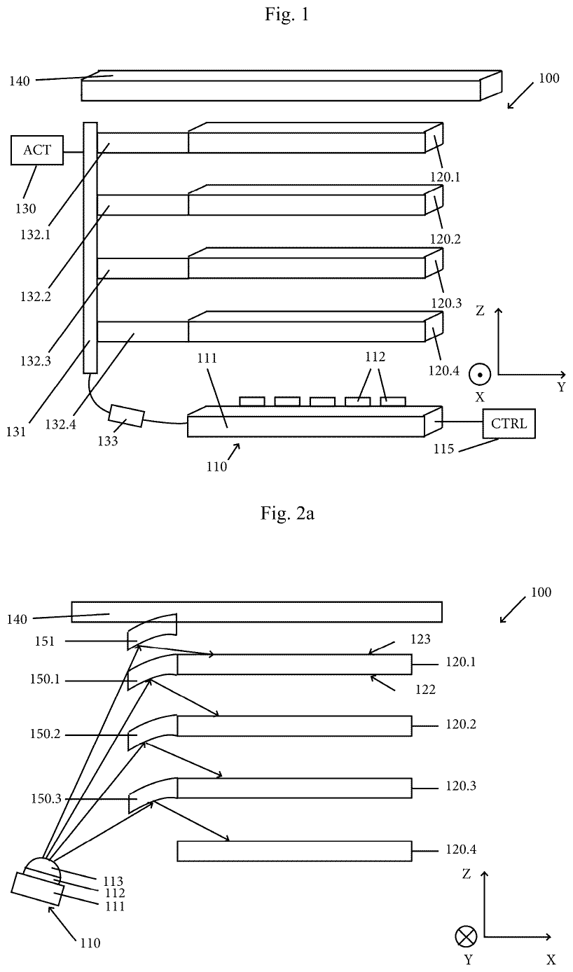

FIG. 1 is a front view, in a plane Y-Z, of a device 100 for an automotive vehicle according to embodiments of the invention.

The device 100 comprises at least one movable shutter element 120.1. In FIG. 1, for illustrative purposes, the device 100 is considered to comprise four movable shutter elements 120.1 to 120.4, the movable shutter elements being movable between at least one open position, and a closed position. Preferably, the movable shutter elements can be tilted between a closed position, at least one partially open position and a fully open position.

For example, the movable shutter elements may be moved by transmitting a mechanical rotational force from a common shaft 131, which can be driven in rotation about the axis Z by an actuator 130. However, any other rotational and/or translational movement may be provided according to the invention to move the movable shutter elements between the various open and closed positions.

The actuator 130 can be controlled electronically by control signals coming from a control element of the vehicle, such as a centralized electronic control unit (ECU). The control element can notably control the actuator 130 as a function of parameters evaluated from data from sensors in the vehicle. This enables the air flow entering through the openings created by the movable shutter elements to be adapted as a function of the environment of the vehicle and/or operation thereof. In a variant, the actuator 130 may be activated manually by a user of the vehicle.

The mechanical force from the shaft 131 can be transmitted to the movable shutter elements 120.1 to 120.4 by means of first mechanical transmission elements 132.1 to 132.4, notably enabling the mechanical rotational force along the axis Z of the shaft 131 to be converted into a rotational force along the axis Y and/or a translational force along the axis Z and/or along the axis X. There are no restrictions related to the rotational and/or translational movement applied to the movable shutter elements 120.1 to 120.4 in order to move them between open and closed positions.

The device 100 may be a shutter for an active grille of a vehicle, which can be placed at the front of the vehicle, and capable of selectively allowing an air flow through to cool the components located at the front of the vehicle, notably the engine. Alternatively, the device 100 may be a shutter for internal ventilation of the vehicle, which can be actuated manually or electronically by the user of the vehicle. In general, the device 100 covers any device in a vehicle that performs a given function by moving at least two shutter elements between at least one open position, and a closed position.

According to the invention, the device 100 may further comprise at least one light source 110 capable of emitting light toward the shutter elements 120.1 to 120.4. In particular, as can be seen more clearly in the following figures, said at least one light source is arranged and able to emit light toward a first end of at least one movable shutter element 120.1 to 120.4, and preferably toward the respective first ends of all the movable shutter elements 120.1 to 120.4.

There are no restrictions related to the technology of said at least one light source 110. In the example described with reference to the figures, given by way of illustration, the light source 110 comprises several electroluminescent elements 112, for example LEDs, distributed at several longitudinal positions along the axis Y of a support or substrate 111, which may advantageously be a printed circuit board (PCB). Such a distribution along the axis Y makes it possible to light the entire width of the movable shutter elements 120.1 to 120.4. However, the invention also applies to a light source 110 comprising a single luminous element, such as an electroluminescent element 112, lighting only a portion of the width of the movable shutter elements 120.1 to 120.4. As described below, the light source 110 may comprise several electroluminescent elements 112 for a given position on Y.

The electroluminescent elements 112 are advantageously mounted on a given PCB 110 in order to facilitate their mounting in the device 100, as well as their control by a control unit 115. The control unit 115 may be dedicated to controlling the light source 110, or may perform another control function. The control element 115 may for example be the aforementioned centralized control unit ECU.

In a variant, each electroluminescent element 112 is mounted on a dedicated printed circuit board. The control element 115 is then connected to all the dedicated printed circuit boards of the electroluminescent elements 112. In another variant, the electroluminescent elements are divided into groups, and each group is mounted on a dedicated printed circuit board 111, thus forming several light sources 110.

In addition, a heat dissipation element, not shown in the figures, such as a radiator, may advantageously be placed beneath the support 111 in order to dissipate the heat emitted by the electroluminescent elements.

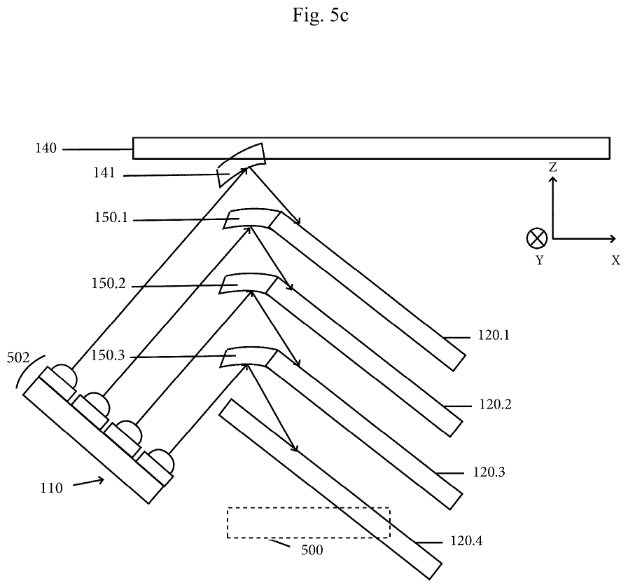

The light source 110 may be fixed. In a variant, the light source 110 may be movable, in order to adapt the position of the light source 110 to the movement of the movable shutter elements 120.1 to 120.4. To this end, the light source 110 may be mechanically connected to the actuator 130. For example, the light source 110 may be connected to the actuator 130 by means of the transmission shaft 131 and a second transmission element 133. The transmission element 133 may be capable of converting, linearly or non-linearly, the rotational movement of the transmission shaft 131 about the axis Z into a movement of the light source 110 in rotation about the axis Y, and/or in translation along the axis X and/or the axis Z. Such a variant in which the light source 110 is movable is described in detail with reference to FIGS. 5a to 5c.

The device 100 may also comprise a frame 140 shown in part in FIG. 1. The frame 140 can fastened and partially surround at least some of the elements of the device 100 which have been described above.

The frame 140 may notably comprise an upper face which is shown in FIG. 1, located above the movable shutter element 120.1 along the axis Z.

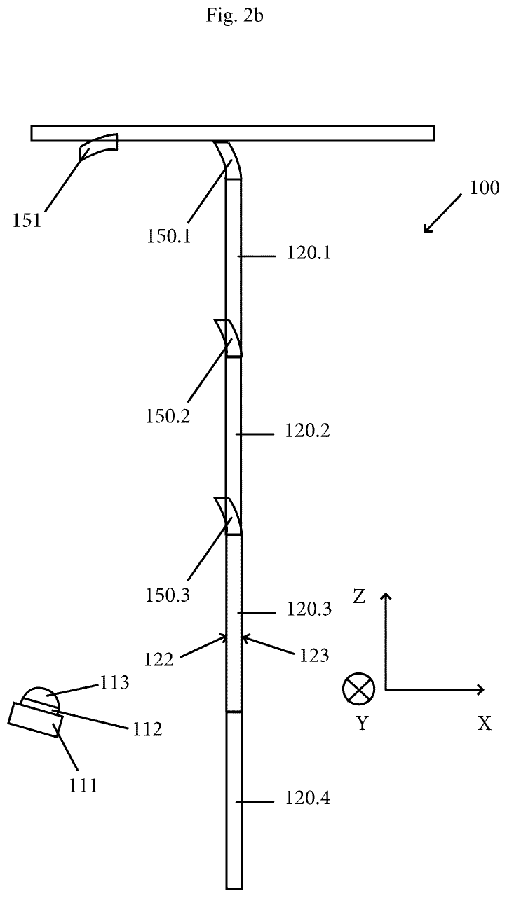

FIG. 2a is a side view, in the plane X-Z, of a device 100 for an automotive vehicle according to a first embodiment, in a first configuration.

According to the first embodiment, the light source 110 comprises a single electroluminescent element 112 for a given longitudinal position on Y. The light source 110 may furthermore comprise a single electroluminescent element for a single longitudinal position on Y.

In the first embodiment, the electroluminescent element 112 may be capable of emitting light with low directivity, i.e. in a wide range of directions. In particular, the electroluminescent element 112 is capable of emitting light toward all the movable shutter elements 120.1 to 120.4. Such low directivity can be achieved by the intrinsic characteristics of the electroluminescent element 112. The electroluminescent element 112 may however be associated with a collimator 113 capable of creating a light cone dimensioned to enable light rays to be transmitted to all the movable shutter elements 120.1 to 120.4.

In FIG. 2a, the movable shutter elements are in the fully open position, extending substantially along the axis X, so as to allow an air flow to circulate substantially along the axis X, from right to left in FIG. 2a.

FIG. 2b shows the same device according to the first embodiment as shown in FIG. 2a, but in a second configuration, corresponding to a closed position of the movable shutter elements 120.1 to 120.4.

Thus, FIGS. 2a and 2b show the first embodiment in two different configurations corresponding respectively to a fully open position of the movable shutter elements 120.1 to 120.4, and to a closed position of the movable shutter elements 120.1 to 120.4.

As explained above, intermediate open positions can be defined for the movable shutter elements 120.1 to 120.4 between the extreme positions in FIGS. 2a and 2b.

Each movable shutter element 120.1 to 120.4 comprises a first face 122 and a second face 123 opposite the first face. For at least one movable shutter element, the first face 122 can face a second face 123 of another movable element when the movable shutter elements are in an intermediate or fully open position.

In the example considered in FIG. 2a, the first face 122 of the movable shutter element 120.3 faces the second face 123 of the movable shutter element 120.4, the first face 122 of the movable shutter element 120.2 faces the second face 123 of the movable shutter element 120.3, and the first face 122 of the movable shutter element 120.1 faces the second face 123 of the movable shutter element 120.2.

For the shutter elements 120.1, 120.2 and 120.3 having a first face 122 facing a second face 123 of another movable shutter element, the movable shutter elements are shaped and arranged so that the first faces directly receive light rays emitted by the light source 110, and so that the second faces are positioned so as not to directly receive any light rays emitted by the light source.

The movable shutter element 120.4 is in the extreme low position along the axis Z. The light source 110 is configured and positioned so as not to emit any light rays toward the movable shutter element 120.4.

According to the invention, for at least one of the movable shutter elements 120.1, 120.2 and 120.3 having a first face 122 facing a second face 123 of another movable shutter element, the first face 122 comprises a reflective element, capable of reflecting at least some of the light rays coming from the light source 110 toward the second face 123 of the other movable shutter element, in one or more open positions. Thus, the second face 123 of the other movable shutter element is advantageously lighted in one or more open positions, thus making the other movable shutter element visible to an observer outside the device, located notably to the right of the device 100 in FIGS. 2a and 2b.

Preferably, for all of the movable shutter elements 120.1, 120.2 and 120.3 having a first face 122 facing a second face 123 of another movable shutter element, the first face 122 comprises a reflective element, capable of reflecting light rays coming from the light source 110 toward the second face 123 of the other movable shutter element.

Thus, a plurality of movable shutter elements of the device 100 are made visible to an external observer.

The reflective element may be a mirror or reflective paint arranged on the first face 122 of the movable shutter element. Preferably, the reflective element is arranged only on the first face 122 at a first end portion of the movable shutter element that can be lighted by the light source 110. In FIGS. 2a and 2b, the movable shutter element 120.1 comprises a first end portion 150.1, the movable shutter element 120.2 comprises a first end portion 150.2 and the movable shutter element 120.3 comprises a first end portion 150.3. Each first end portion of a movable shutter element may have a shape defined as a function of the position of the light source 110 and the position and geometry of the second face 123 of the other movable shutter element toward which the light rays are reflected.

In a variant, instead of being arranged on the first face of the first end of a movable shutter element, the mirror is aligned with the first face of the first end portion, next to the movable shutter element. In this case, the reflective element may correspond to reference signs 150.1 to 150.3.

As the second face 123 of the movable shutter element 120.1 is arranged so as not to receive light rays directly from the light source, the frame 140 may comprise another reflective element 151 positioned so as to receive light rays directly from the light source 110 and to reflect at least some of the light rays toward the second face 123 of the movable shutter element 120.1.

Thus, all the movable shutter elements 120.1 to 120.4 can be made visible.

When several light sources 112 are distributed at several positions on Y across the width of the device 100, several reflective elements may be provided on each movable shutter element 120.1, 120.2 and 120.3, as well as several reflective elements 151, at several positions on Y. In a variant, for each movable shutter element, the reflective element extends continuously over the entire width of the movable shutter element, just as the reflective element 151 may extend over this same width.

With reference to FIG. 2b, in the closed position, no light rays coming from the light source 110 leave the device 100. Advantageously, the control element 115 can turn off the light source 110 when the movable shutter elements 120.1 to 120.4 are in the closed position.

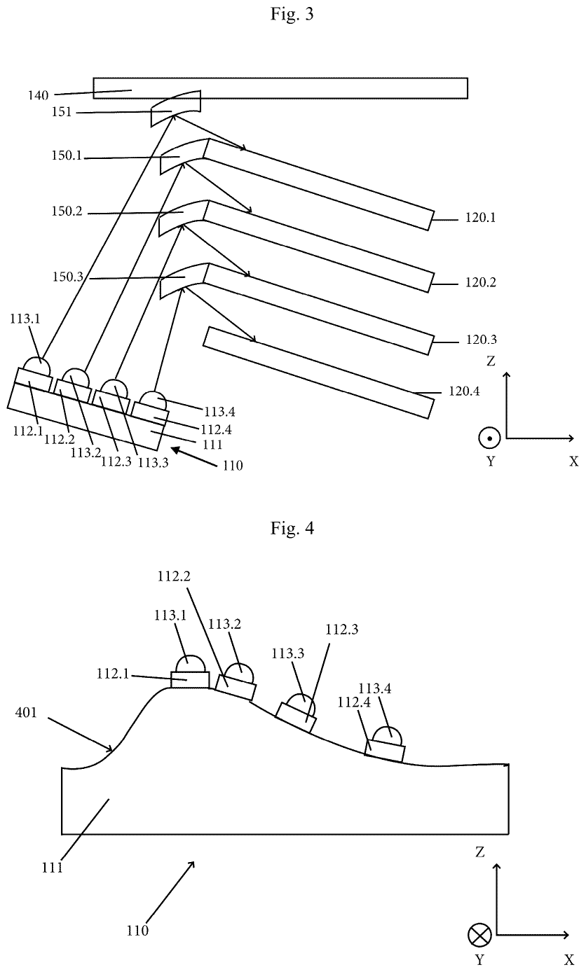

FIG. 3 is a side view, in the plane X-Z, of a device according to a second embodiment, in a given configuration, corresponding to an intermediate open position of the movable shutter elements 120.1 to 120.4.

The intermediate open position configuration is given for illustrative purposes only. It should be noted that the second embodiment can be implemented in the case where the movable shutter elements can occupy only the two positions, fully open and closed, described with reference to FIGS. 2a and 2b.

According to the second embodiment, the light source 110 comprises several luminous elements, notably several electroluminescent elements, at a given longitudinal position on Y, each electroluminescent element being arranged so as to emit light rays toward only one of the reflective elements, i.e. either toward the element 151, or toward the reflective element of the first end portion 150.1, or toward the reflective element of the first end portion 150.2, or toward the reflective element of the first end portion 150.3.

Preferably, the light source comprises as many electroluminescent elements at a given position on Y as the device 100 comprises movable shutter elements. In the example illustrated in FIG. 3, the light source 110 can thus comprise four electroluminescent elements 112.1, 112.2, 112.3 and 112.4.

Thus, in the second embodiment, the electroluminescent elements have greater directivity than in the first embodiment. In particular, the light cone emitted by each light source may have an angle of a few degrees, notably less than 10°, or less than 5°, or less than 3°.

The second embodiment thus provides better luminous efficacy compared with the first embodiment, and the electroluminescent elements 112.1 to 112.4 may be less powerful than the electroluminescent element 112 of the first embodiment.

According to the second embodiment, the light source may comprise N electroluminescent elements for each position on Y, and the electroluminescent elements thus form an array of electroluminescent elements, N being greater than or equal to 2. As a variant, the light source 110 may comprise N electroluminescent elements at a single position on Y.

According to the second embodiment, the electroluminescent elements can be replaced by individual light sources distributed in an array.

High directivity of the light beams emitted by the electroluminescent elements 112.1 to 112.4 can be achieved by the intrinsic characteristics of the electroluminescent elements 112.1 to 112.4 and/or by the addition of respective collimators 113.1 to 113.4.

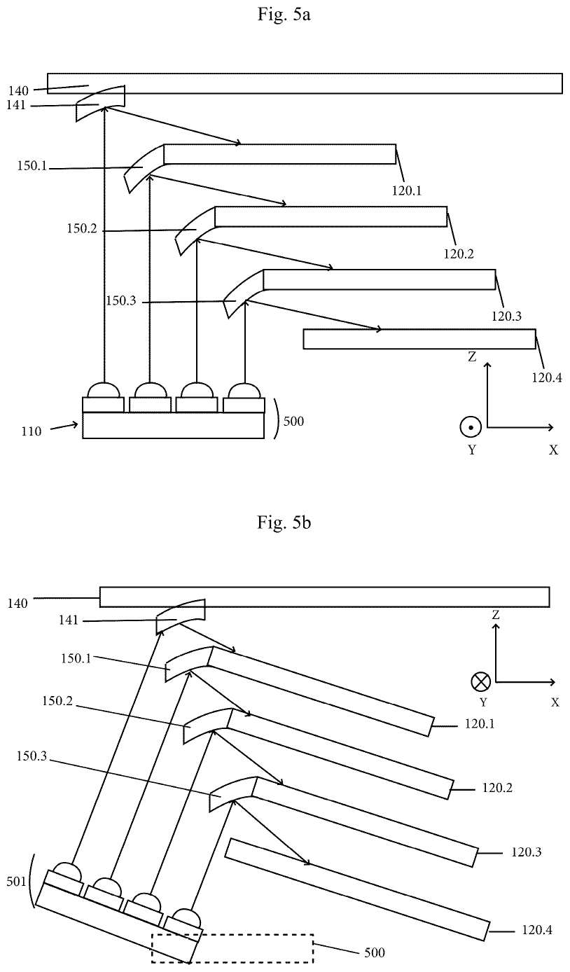

FIG. 4 shows a light source 110 of a device 100 according to the second embodiment.

The light source 110 in FIG. 4 can thus be included in the device 100 illustrated in FIG. 3.

According to the second embodiment, the electroluminescent elements 112.1 to 112.4 may have:
different orientations; and/or
different positions on Z.

To this end, the PCB 111, or more generally the substrate or support on which the electroluminescent elements 112.1 to 112.4 rest, may have a non-planar face 401 on which the electroluminescent elements are arranged. The face 401 is thus shaped so as to define different orientations and/or different positions on Z and on X for the electroluminescent elements 112.1 to 112.4. The orientations and the positions on Z and on X may be defined on the basis of one or more parameters, such as:
the distance from the reflective element associated with each electroluminescent element;
the geometrical characteristics of the reflective elements and of the movable shutter elements 120.1 to 120.4;
the optical characteristics of the electroluminescent elements 112.1 to 112.4; and/or
the optical characteristics of the collimators 113.1 to 113.4.

In particular, such parameters may be optimized as a function of design criteria, for example the uniformity of the lighting of the various movable shutter elements 120.1 to 120.4.

FIGS. 5a to 5c are side views of a device 100 for an automotive vehicle according to a third embodiment, in several different configurations.

The configuration in FIG. 5a corresponds to fully open positions of the movable shutter elements 120.1 to 120.4, while FIGS. 5b and 5c correspond to intermediate or partially open positions of the movable shutter elements 120.1 to 120.4. There are no restrictions related to the number of intermediate open positions.

The light source 110 of the third embodiment comprises four electroluminescent elements per position on Y, as in the second embodiment. However, the light source 110 according to the third embodiment is movable. The third embodiment can thus be considered as complementary to the first embodiment.

The features detailed below with reference to FIGS. 5a to 5c also apply to a light source 110 comprising a single electroluminescent element per position on Y, like the light source 110 of the first embodiment of FIGS. 2a and 2b. However, in the third embodiment, the light source 110 is also movable. The third embodiment can thus be considered as complementary to the second embodiment as well.

In the first configuration, the light source 110 is in a first position 500. In the second configuration, the light source 110 is in a second position 501. In the third configuration, the light source is in a third position 502.

The three positions 500 to 502 may vary by their positions on X, their positions on Z and by their inclinations with respect to the axis Y, as shown in FIGS. 5a to 5c.

In general, the path formed by the positions 500 to 502 may be a linear function or a non-linear function of the path formed by the positions of the movable shutter elements 120.1 to 120.4. Preferably, a non-linear function may be used because any path can then be obtained for the light source 110, which makes it possible to optimize the path of the light source 110 as a function of the geometry and the respective arrangements of the movable shutter elements, as well as the position and inclination of the electroluminescent elements of the light source 110 on the substrate 111.

The function connecting the path is defined by the second transmission element 133 illustrated in FIG. 1.

In order to define a non-linear function, the transmission element may be a connecting rod-crank device or a camshaft. The operating principle of such mechanical elements is well known and is not described in greater detail in the present description.

The lighting of the movable shutter elements is thus improved, in several intermediate open positions. In particular, uniform lighting of the movable shutter elements in all the open positions.

The present invention is not limited to the embodiments described above by way of examples; it covers other variants.

What is claimed is:

1. A device for an automotive vehicle, comprising:
at least two movable shutter elements, each movable shutter element including a first face and a second face;
an actuator capable of moving the at least two movable shutter elements to a closed position of the device and to at least one open position of the device;
at least one light source arranged to emit light rays toward at least one movable shutter element, the first face of which is arranged to face a second face of another movable shutter element, in the at least one open position;
in which the at least one movable shutter element toward which the light rays from the at least one source are emitted is integral with a reflective element capable of reflecting at least some of the emitted light rays toward the second face of the other movable shutter element, in the at least one open position.

2. The device as claimed in claim 1, further comprising at least two reflective elements arranged to reflect some of the light rays from the at least one light source toward at least two respective second faces of two movable shutter elements.

3. The device as claimed in claim 2, wherein the at least one light source includes at least one luminous element able and arranged to emit light rays toward the at least two reflective elements.

4. The device as claimed in claim 2, wherein the at least one light source includes at least two luminous elements each luminous element being able and arranged to emit light rays toward only one of the at least two reflective elements.

5. The device as claimed in claim 1, wherein the movable shutter elements extend longitudinally in a first direction, wherein the at least one light source extends longitudinally in the first direction, and wherein the at least one light source includes at least one luminous element; for each longitudinal position in a set of longitudinal positions in the first direction.

6. The device as claimed in claim 5, wherein for each longitudinal position, the device includes N reflective elements and the light source includes N luminous elements, each luminous element being capable of emitting light rays to only one of the N reflective elements, N being greater than or equal to 2.

7. The device as claimed in claim 6, wherein, for each longitudinal position, the luminous elements are arranged on a face of a given support, in which the face of the support is shaped to define respective inclinations of the luminous elements and/or respective positions of the luminous elements along a first axis perpendicular to a longitudinal axis and along a second axis perpendicular to the longitudinal axis, the first axis and the second axis being perpendicular to each other;
wherein the respective inclinations and/or positions along the first and second axes perpendicular to the longitudinal axis are different for at least two reflective elements of the N reflective elements.

8. The device as claimed claim 1, further comprising a frame and a reflective element fastened to the frame, wherein the at least one light source is capable of emitting light rays toward the reflective element fastened to the frame, and the reflective element fastened to the frame is capable of reflecting at least some of the light rays toward a second face of a movable shutter element, the second face of which is not facing any first face of another movable shutter element.

9. The device as claimed in claim 1, wherein the actuator is capable of generating a mechanical force to move the movable shutter elements, and the device further comprises a mechanical element capable of transmitting the mechanical force generated by the actuator to the at least one light source.

10. The device as claimed in claim 9, wherein the mechanical element is a camshaft capable of converting the mechanical force of the actuator into a path of the light source by means of a non-linear function.
